(19) United States
(12) Patent Application Publication
(10) Pub. No.: US 2003/0060158 A1
(43) Pub. Date: Mar. 27, 2003

(54) Infrastructure-based communications network

(75) Inventors: John Philip Riganati, Skillman, NJ (US); David Wayne Ihrie, Princeton Junction, NJ (US); David Kalokitis, Robbinsville, NJ (US); Jonathan Lloyd Schepps, Princeton Jct., NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/961,826

(22) Filed: Sep. 24, 2001

(51) Int. Cl. H04Q 7/20

(52) U.S. Cl. 455/11.1; 455/426

(57) ABSTRACT

A method and apparatus for providing improved communications comprising the step of providing an infrastructure-based communication network, connecting said infrastructure-based communications network to a primary communications system and introducing users of personal communication devices to said infrastructure-based communications network. The step of providing an infrastructure-based communications network includes the steps of adapting existing infrastructure devices to relay electromagnetic radiation that is propagated by the primary communications system. The adapted infrastructure devices are selected from the group consisting of manhole covers, sewer gratings, ventilation gratings, storm drain gratings, utility poles, lighting poles, telephone junction boxes and traffic signal junction boxes. An apparatus for providing improved communications within an urban environment comprises a plurality of urban infrastructure-based devices adapted to interact with a primary communications system. The primary communications system is selected from a group consisting of existing wireless communications networks and wireless Internet service provider networks.

### BACKGROUND OF THE INVENTION

1. Field of the Invention

The present invention generally relates to a wireless communications network. More specifically, the invention is directed to a wireless communications network established in an urban environment using existing infrastructure as part of the antenna array. The antenna array is then inter-connected to a variety of existing communication networks.

2. Description of the Related Art

There is a rapidly accelerating worldwide expectation for an “always on” wireless communications infrastructure to support aggressive new services. Because of the highly non-uniform coverage of wireless signals in the United States, the US infrastructure is not as ready to support the delivery of such services as infrastructures in other parts of the world. The gaps in coverage which result in dropped cell phone calls and poor quality of service in many regions of the United States, particularly in metropolitan areas, are well known and constantly frustrating to users of wireless communications. There are two fundamental reasons for these difficulties: societal issues which have prevented the building of new structures or, often, even the use of existing structures to house antennas and the deployment of other resources which are considered unaesthetic; and technological issues involving the lack of maturity in end-to-end solutions provided by multiple completing vendors in the United States.

Throughout the United States, the ownership and rights of the electric power distribution utility has been undergoing dramatic change. In a majority of the 53 public utility districts, the local electric power utility has been encouraged, and sometimes mandated, to divorce itself from the generation of electric power and to offer access to its electric power distribution grid to competing providers of electric power. This has caused numerous electric utilities to have accumulated significant assets caused by the sale of their power distribution capabilities and has caused them to seek new business models consistent with the assets under their stewardship. Accordingly, the electric power utilities of the United States are well situated both in terms of physical asset control and in terms of aggressive legislation regulating their role in society, to become carriers of information as well as carriers of electric power. In some instances, electric utilities have explored using their existing networks of cables and wires to carry information. Yet, wireless communication networks in conjunction with public utility physical assets has not been investigated.

Therefore, there is a need in the art for an improved communication network that eliminates local dropouts or disruptions in service without adding to the complexity of the equipment within the system or adding undesirable or unaesthetic structures to an existing environment.

### SUMMARY OF THE INVENTION

The present invention generally consists of a method for providing improved communications comprising the step of providing an infrastructure-based communication network, connecting said infrastructure-based communications network to a primary communications system and introducing users of personal communication devices to said infrastructure-based communications network. The step of providing an infrastructure-based communications network includes the steps of adapting existing infrastructure devices to relay electromagnetic radiation that is propagated by the primary communications system. The adapted infrastructure devices are selected from the group consisting of manhole covers, sewer gratings, ventilation gratings, storm drain gratings, utility poles, lighting poles, telephone junction boxes and traffic signal junction boxes. Such infrastructure devices may function as active or passive antenna components. The method further comprises the step of allowing users in the infrastructure-based communications network to access users in a second infrastructure-based communications network. Such additional step further comprises the steps of providing a second infrastructure-based communications network in a second urban environment and inter-connecting said second infrastructure based communications based network to a primary communications system.

The invention also provides for an apparatus for providing improved communications within an urban environment comprising a plurality of urban infrastructure-based devices adapted to interact with a primary communications system. Such apparatus has existing infrastructure-based devices are selected from a group consisting of manhole covers, sewer gratings storm drain gratings, ventilation grating, utility poles, lighting poles, telephone junction boxes and traffic signal junction boxes. The existing infrastructure-based devices are adapted with active or passive antenna components. The passive antenna components are conductive members disposed when the existing infrastructure-based devices whereas the active antenna components are powered electronic devices disposed within or upon the existing infrastructure-based devices. A frequency range for the network is approximately 600 MHz-2500 MHz and the primary communications system is selected from a group consisting of existing wireless communications networks and wireless Internet service provider networks.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system level view of the improved communications network;

FIG. 2 depicts a second embodiment of the communications network;

FIG. 3 depicts a block diagram of an exemplary computer system integrated into the communications network;

FIG. 4 depicts one embodiment of antenna array components having passive antenna systems;

FIG. 5 depicts a second embodiment of antenna array components having active antenna systems;

FIG. 6 depicts a method of providing improved wireless communication in accordance with the subject invention;

FIG. 7 depicts a third embodiment of the communications network.

### DETAILED DESCRIPTION OF THE PREFERRED EMBODIMENT

The present invention will be described within the context of a communications network, more specifically a wireless communications network existing in an urban environment, that is utilized by a vast number of customers. However, it will be appreciated by those skilled in the art that the communications network described herein is readily applicable to any communications network where lapses in coverage exist, yet can be accommodated, accounted for, or otherwise improved by utilizing existing infrastructure of the environment in which the communications network exists.

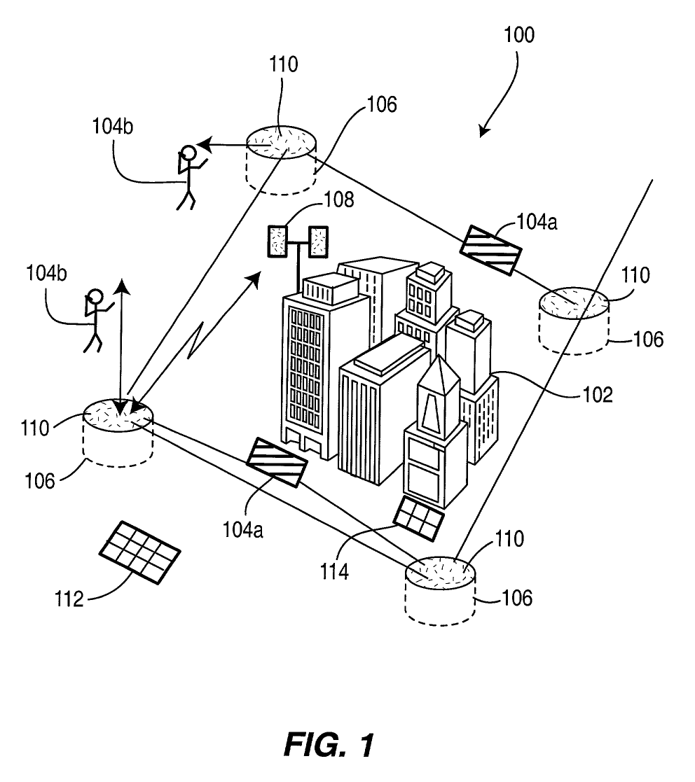

FIG. 1 depicts a system level view of the communications network 100 existing within an urban environment 102 (i.e., an exemplary city block in a grid system of city blocks in a densely packed metropolitan or urban environment). Many of the services provided to dwellers and businesses of the urban environment 102 are located below ground and are accessed at different surface locations within the urban environment. For example, electrical, gas, water, cable and sewer distribution lines are accessed by manholes 106 (shown in phantom as they are actually below the surface of the urban environment 102). Since these manholes are actually subterranean chambers that the public should not have access to, each manhole is provided with a manhole cover 110. These manhole covers 110 are usually fabricated of cast iron and weigh on the order of 300 pounds so as to prevent theft, vandalism or the like. Similarly, other types of urban infrastructure exist within the urban environment 102. For example, a vast network of subterranean storm drains exist which provide a path for storm waters or run off to drain without effecting or otherwise flooding the urban environment. The runoff enters this storm drain network through a plurality of sewer gratings 112 provided at strategic points in the urban environment (usually corners or low points of a graded roadway surface.) Still further existing urban infrastructure includes gratings 114 for providing ventilation for subterranean high voltage distribution of equipment (transformer substations). Such gratings are usually found periodically in the sidewalks of the urban environment 102. Thus, a vast network of existing surface-based urban infrastructure is available for adaptation and integration into a communications network. The adaptation of the existing infrastructure (manhole covers 110, storm drain gratings 112 and the ventilation gratings 114) can be either retrofitted or redesigned to act as antennas for the communications network 100 and is described in greater detail below. As such, users of the communications network 100 have a more comprehensive antenna array, hence access points, to interact with other users in the network. Communications network users include vehicles 104A having portable wireless communication devices (i.e. cellular car phones) and pedestrians 104B having personal communication devices (cell phones, wireless personal digital assistants (PDAs and the like). Such users 104A, B can use the existing urban infrastructures 110, 112 and 114 to access a larger and more powerful main antenna 108 strategically located within the urban environment 102. Accordingly, a large number of intermediate nodes are available for users of the communications network which results in any significant decrease in areas where access to the main antenna 108 may otherwise be blocked or interfered with. The main antenna 108 is also representative of an existing wireless communication system and its computer hardware or server previously established in the urban environment.

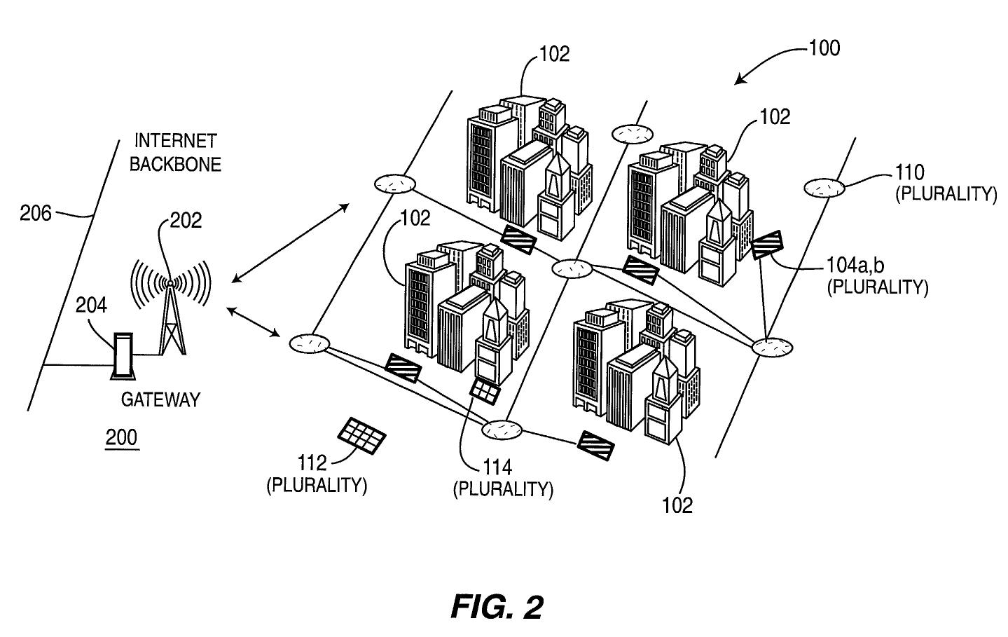

FIG. 2 depicts a second embodiment of an overview of the system 100 communicating with an additional information service 200. Specifically, the communication network 100 is identical to that depicted in FIG. 1 in that there are a plurality of existing infrastructure devices (which include manhole covers 110, storm drain gratings 112 and ventilation gratings 114 and or the like) and that allow for increased signal coverage area in the urban environment 102. Note that in FIG. 2 the urban environment has been expanded to include four city blocks to give a better representation of the grid environment that exists in such an area. While the first embodiment has provisions for allowing greater signal coverage access to a cellular telephone communications network (represented by cellular tower 108) there are a variety of other systems that would enjoy the benefit of increased signal coverage within the urban environment 102. By way of representative example, a wireless Internet communication service 200 (i.e. an existing service or one developed specifically for the urban environment 102) is provided. The wireless internet communication network 200 includes a main antenna 202, a gateway 204 and internet backbone 206. More specifically, the antenna 202 is any antenna capable of transmitting and receiving signals within a communications band of approximately 1900 MHz-2500 MHz. Such antenna would be strategically located within the urban environment so as to provide the greatest possible signal coverage to customers 104A, B within the urban environment. The gateway 204 is any type of large-scale computer system or server capable of relaying information to and from the internet backbone structure 206 and the antenna 202 and is discussed in greater detail below. The Internet backbone 206 is, for example, the existing array of computers, servers and stored information that currently exists as the Internet in a “hard-wired” form. The wireless Internet communication system 200 in conjunction with the improved communications network 100 provides additional signal coverage to users 104A, B who desire access to the Internet (for example for email communication, access information via the Internet and the like).

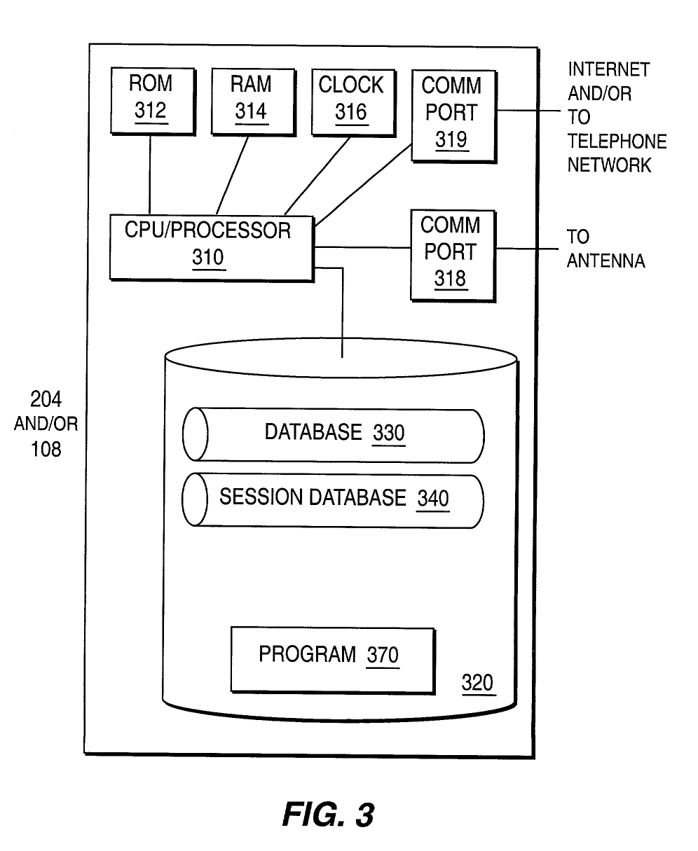

FIG. 3 is a block diagram of an exemplary embodiment of the server/systems 204 and/or 108 illustrated in FIGS. 1 and 2, and in accordance with the principles of the present invention. Servers/Systems 204/108 preferably include certain standard hardware components, such as a central processing unit (CPU) 310, a data storage device 320, a read only memory (ROM) 312, a random access memory (RAM) 314, a clock 316 and a plurality of communications ports 318 and 319. The CPU 310 is preferably linked to each of the other listed elements, either by means of a shared data bus, or dedicated connections. The CPU 310 may be embodied as a single processor, or a number of processors operating in conjunction with one another. The data storage device 320 and/or a ROM 312 are operable to store one or more instructions, which the CPU 310 is operable to retrieve, interpret and execute. The CPU 310 preferably includes a control unit, an arithmetic logic unit (ALU), and a CPU local memory storage device, such as, for example, a stackable cache or a plurality of registers, in a known manner. The control unit is operable to retrieve instructions from the data storage device 320 or ROM 312. The ALU is operable to perform a plurality of operations needed to carry out instructions. The CPU local memory storage device is operable to provide high-speed storage used for storing temporary results and control information.

The data storage device 320 typically includes one or more machine-readable media; such media include, as is well known in the art, magnetic, semiconductor and optical media. Data storage device 320 is preferably capable of supporting searching and storing of data. Data storage device 320, or portions thereof, may reside on a single computer or server, or may be distributed in a known manner among a plurality of computers or servers.

The data storage device 320 preferably includes a user data base 330, a session data base 340 as well as other applications, code and programs 370 resident at the data storage device 320. The user data base 330 preferably includes specific data pertaining to user accounts. The session data base 340 preferably includes session specific data pertaining to the accessing and consumption of information by a network operator or authorizer user. The communications ports 318 and 319 connects the servers 204/108 to the Internet or other communications network such as an existing telephone switching network and main antenna systems (i.e., antenna 202 or 108).

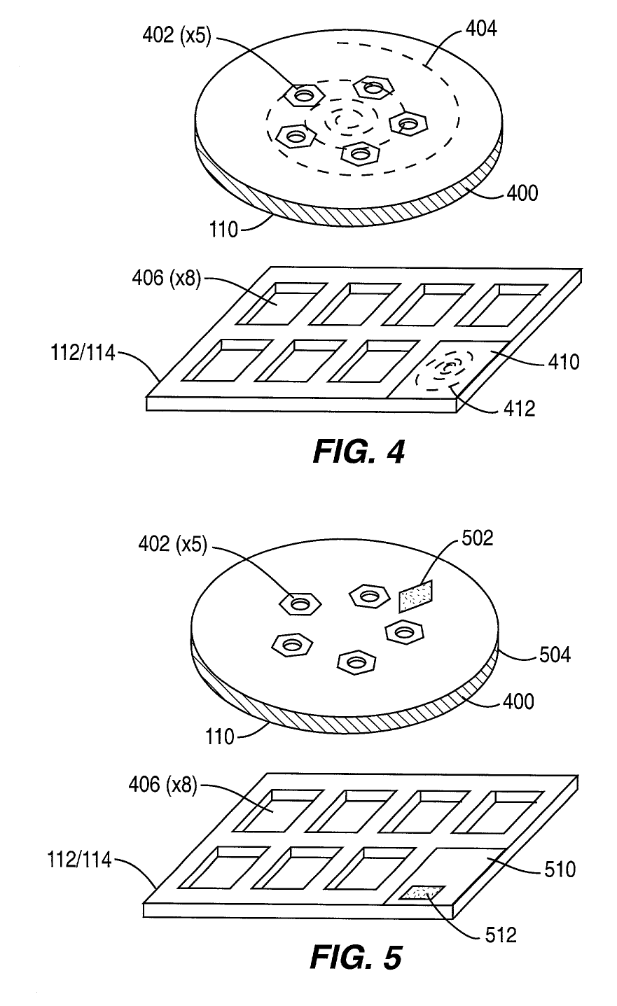

FIG. 4 depicts examples of existing urban infrastructure that has been adapted to become part of the communication network 100 as described. One possible embodiment as seen and described in detail below is for a passive radiating antenna system. For example, manhole cover 110 is shown as a disk shaped object. The manhole cover 110 further comprises a plurality of vent holes 402 which serve to vent sewer gases or equalize air pressure differences between the manholes 106 and the outside atmosphere. Additionally, an antenna structure 404 is embedded or otherwise disposed upon or within the manhole cover 110. For example, FIG. 4 shows a conductive material embedded within the manhole cover 110 in an outwardly spiraling configuration. Such configuration is useful for receiving and transmitting the desired communication wavelengths in a bandwidth of approximately 925-2500 MHz (i.e., existing networks in PCS bands operate at approximately 1910 MHz and 2400 MHz, unlicensed ISM bands operate at approximately 925 MHz, and MMDS bands operate at 2500 MHz). The manhole cover in this particular embodiment is fabricated of a composite material. Such composite material may be selected from the group consisting of fiberglass epoxy, carbon fiber and similar materials which are structurally strong enough and weather resistant enough to support the load bearing and weathering requirements of an urban street environment and are characterized by low RF loss so they provide a suitable environment for an embedded antenna. While the frequency ranges and materials above have been disclosed, in principle any combination of frequency and material selection for which sufficient power to overcome the propagation losses and permit an economically attractive implementation without danger to life is useable. Such combinations are readily apparent to one ordinarily skilled in the art.

Because such composite material is usually lighter than the original manhole cover, the composite material manhole cover can be provided with serrations or threads 400 about its circumference. Such feature provides for securing the manhole cover 110 to a rim structure (not shown) of the manhole 106. That is, the rim structure and manhole cover 110 can be fitted with communicating thread patterns so as to prevent possible blow out, theft, or vandalism. FIG. 4 also shows one of the storm drain gratings or a ventilation gratings 112/114 with the appropriate adaptations made. Specifically, the grating 112/114 is shown as a rectangular plate having a plurality of ventilation or otherwise access ports 406 provided therein. The access ports 406 allow either a runoff to enter into a storm drain system or allow for ventilation between a subterranean cavity and the outside environment. The grating 112/114 is further provided with an embedded antenna structure 410. That is, a portion of the original grating 112/114 is removed and replaced with the antenna structure. The antenna structure is, for example, a composite material (similar to that of the adapted manhole 110 described above having disposed therein a conductive antenna member 412. While examples of surface-based passive antenna systems have been described in detail, one skilled in the art will understand and appreciate that any number of other existing urban infrastructure components may be similarly outfitted or modified for antenna usage. For example, utility poles, light (street, traffic signal or the like) poles, telephone or traffic signal junction boxes can all be appropriately designed or retrofitted to act as antennas. Such additional structures are above-surface structures (in comparison to gratings and manhole covers), but can be designed to propagate signals in the same manner s the surface-based structures.

FIG. 5 depicts alternate embodiments of the adapted manhole cover and sewer/ventilation grating. Specifically, these embodiments incorporate active antenna devices within these urban infrastructure objects. More specifically, manhole cover 110 is as seen and described in FIG. 4. That is, it may be a composite material with the aforementioned serrations or thread features 400 and ventilation holes 402. Additionally, the manhole cover 110 is fitted with a powered antenna device 502. Power for the antenna device may be supplied battery pack not shown or by a power source existing in the manhole 106 with appropriate tap connections thereto. Additionally, it should be noted that the power antenna device 502 is disposed on a bottom side 504 of manhole cover 110 to avoid damage, vandalism, theft and the like. However, such placement does not hinder the device's ability to transmit and receive surface level communication wavelengths in the bands described above. With respect to the ventilation/sewer gratings 112/114, it again is shown as a generally rectangular shaped grate structure with access or ventilation ports 406. The adapted structure contains a portion, which has been removed and replaced with a powered (active antenna structure 510). The structure 510 is fitted with the existing rectangular grate structure so as to fit and communicate normally within the urban environment. The structure is also fitted with a powered antenna device 512. Similar to the manhole structure 110 the ventilation-sewer grating 112/114 can have an internal battery pack or be provided with power from an external source neighboring the structure. While examples of surface-based active antenna systems have been described in detail, one skilled in the art will understand and appreciate that any number of other existing urban infrastructure components may be similarly outfitted or modified for antenna usage. For example, utility poles, light (street, traffic signal or the like) poles, telephone or traffic signal junction boxes can all be appropriately designed or retrofitted to act as antennas. Such additional structures are above-surface structures (in comparison to gratings and manhole covers), but can be designed to propagate signals in the same manner s the surface-based structures.

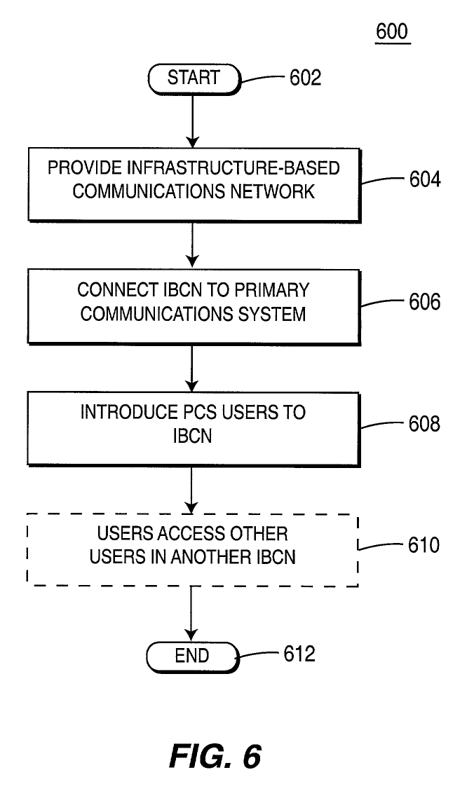

FIG. 6 depicts a series of method steps in accordance with the subject invention in which a method of distributing or otherwise providing electromagnetic transmissions to a user in an urban environment is depicted. Specifically, the method starts at step 602 and proceeds to step 604 wherein an infrastructure-based communications network (IBCN) is provided. The IBCN is, for example, the network 100 seen and described in FIG. 1 and in the written specification above. That is, an antenna array is formed by infrastructure within the urban environment for improved signal coverage of various ground based wireless communication devices (i.e., cell phones, mobile phones and the like). The IBCN is a plurality of, for example, specially prepared or adapted manhole covers, storm drain gratings or ventilation gratings as seen and described above. At step 606, the IBCN is inter-connected to a primary communication system. In one embodiment of the invention, the primary communication system is, for example, a wireless telephone communications network and is represented by main antenna and system 108 of FIG. 1 described above. In an alternate embodiment, the primary communication system is the wireless Internet system 200 as seen and described in FIG. 2. Those skilled in the art will realize that the primary communication system should not be limited to the system described above and any type of communications system that provides relevant information to a user in an urban environment can be connected to the IBCN to provide that information in a satisfactory manner (i.e. without signal dropouts or poor coverage areas). At step 608, users of the primary communication system are introduced to the IBCN. For example, a user of a wireless telephone now has the ability to operate the telephone at any desired location, have a signal from the wireless telephone picked up from one of the infrastructure based communication network objects and relay it to the primary communication system. Once the users have been introduced to the IBCN, information can readily be transmitted and received to the user at any and all desired locations within the IBCN. While cellular telephone networks and the wireless public Internet networks have been described, it is submitted that the primary frequencies for transmission and reception of data between users through the IBCN will be in the range of three GHz and below.

While it has been provided and discussed that existing infrastructure is modified, adapted or otherwise replaced with the appropriate components to establish the IBCN, is not necessary for every single existing infrastructure device to undergo said transition. That is, various known methods of signal analysis and theoretical modeling can be conducted on a block by block basis to analyze the need for the strategic placement of adapted infrastructure devices. In this way, appropriate signal coverage can be optimized without unnecessary expenditure of assets to establish the ICBN.

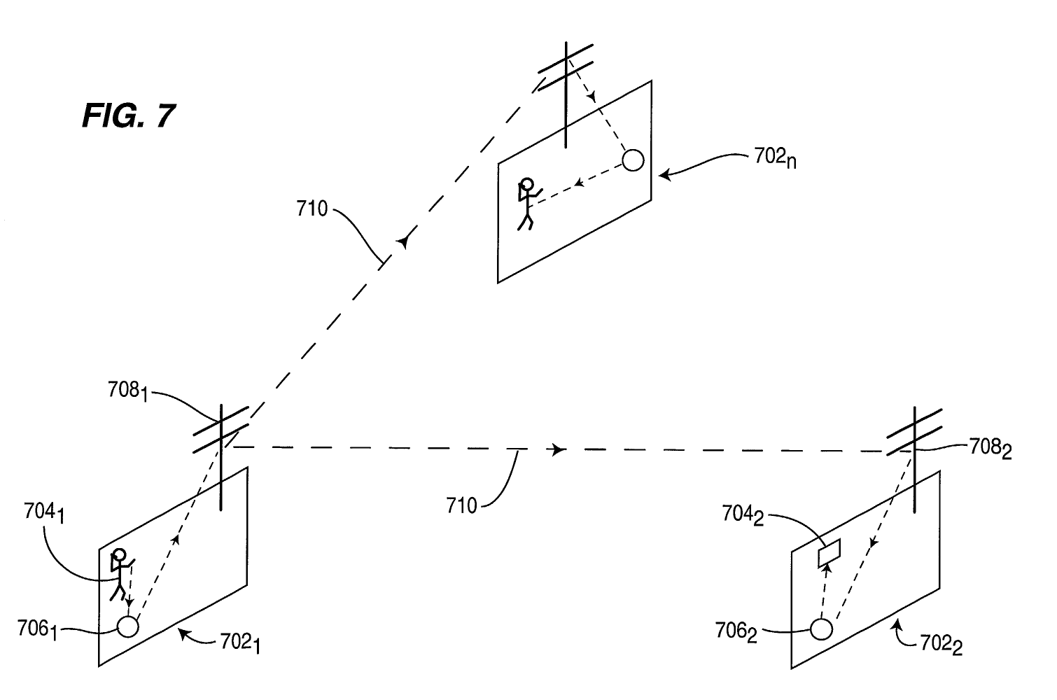

The advantages of the above-identified communications network and method of providing improved communications is discussed as follows. Since the communications network uses existing infrastructure of an electric utility, a relatively uniform and gap-free signal coverage area within the urban environment is created. That is, each of the plurality of existing infrastructure devices (manhole covers 110, storm drain gratings 112 and ventilation gratings 114) increases the network's ability to accept and relay information from a user to the main antenna within the urban environment. More specifically, a network of shaped beams of electromagnetic energy is formed by virtue of the newly created antenna array. Such shaped beam condition provides high signal strength and traffic handling capacity within the urban environment (exactly where the need for coverage and traffic handling is greatest due to a high number of users). Additionally, since the improved communications network has the ability to extend and improve the communication range within a single urban environment, one can easily see that upon proper inter-connecting of the improved communication network to existing communication systems in other urban areas, and by establishing improved communication networks in those additional urban areas, a plurality of improved communication network nodes can be established from one urban environment to another. For example, FIG. 7 depicts a system level view of an expanded improved communications network in accordance with a subject invention. Specifically, a plurality of urban environments 702₁, 702₂, 702ₙ are provided. Each of the urban environments 702 can represent major urban areas or cities such as New York City, N.Y., Detroit, Mich., and San Francisco, Calif. Each of the urban environments 702 is provided with its own improved communications network such as improved communications network 100 shown and described in FIG. 1 and represented in FIG. 7 as 706ₙ. Any one of a number of users 704ₙ within each of the urban environments 702ₙ can contact another individual within another urban environment by accessing the users local improved communications network 706ₙ. For example, user 704₁ in urban environment 702₁ accesses improved communications network 706₁. The information is relayed to the main antenna of the existing communications system 708₁ in the urban environment 702₁ and relays it over any number of signal paths 710 to other urban environments (702₂ for example). The signal is received by the existing communications network 708₂ in urban environment 702₂. The information is then further relayed to the improved communications network 706₂ in the second urban environment 702₂ and finally arrives at the user 706₂ in the second urban environment 702₂. As such, it is provided that a worldwide network can be established to provide improved communications within any number of urban environments having the appropriately configured improved communications network 706.

A method of providing a communications between users in different urban environments is seen and described as an optional step in the previously described FIG. 6. Specifically, after step 608 wherein PCS users have been introduced to the IBCN, users have the option of either accessing their existing communications network to contact a land line based customer or an internet service provider, or another PCS user within the local network. Optionally, the PCS user can attempt to contact another PCS user and another urban environment by accessing the appropriate existing communications systems and then the ICBN of the second user. Such access is represented in step 610 of FIG. 6.

While foregoing is directed to the preferred embodiment of the present invention, other and further embodiments of the invention may be devised without departing from the basic scope thereof, and the scope thereof is determined by the claims that follow.

1. A method for providing improved communications comprising the steps of:
providing an infrastructure-based communications network;
connecting said infrastructure-based communications network to a primary communications system; and
introducing users of personal communication devices to said infrastructure-based communications network.

2. The method of claim 1 wherein the step of providing an infrastructure-based communications network further comprises the steps of adapting existing infrastructure devices to relay electromagnetic radiation and that is propagated by the primary communications system.

3. The method of claim 2 wherein the adapted infrastructure devices are selected from the group consisting of manhole covers, sewer gratings, ventilation gratings, storm drain gratings, utility poles, lighting poles, telephone junction boxes and traffic signal junction boxes.

4. The method of claim 2 wherein the infrastructure devices are passive antenna components.

5. The method of claim 2 wherein the infrastructure devices are active antenna components.

6. The method of claim 1 further comprising step of allowing users in the infrastructure-based communications network to access users in a second structure communications based network.

7. The method of claim 6 wherein the user access step further comprises the steps of providing a second infrastructure-based communications network in a second urban environment and connecting said second infrastructure based communications based network to a primary communications system.

8. An apparatus for providing improved communications within an urban environment comprising a plurality of urban infrastructure-based devices adapted to interact with a primary communications system.

9. An apparatus of claim 8 wherein the existing infrastructure-based devices are selected from a group consisting of manhole covers, sewer gratings storm drain gratings, ventilation grating, utility poles, lighting poles, telephone junction boxes and traffic signal junction boxes.

10. The apparatus of claim 8 wherein the existing infrastructure-based devices are adapted with passive antenna components.

11. The apparatus of claim 8 wherein the existing infrastructure-based devices are adapted with active antenna components.

12. The apparatus of claim 10 wherein the passive antenna components are conductive members disposed when the existing infrastructure-based devices.

13. The apparatus of claim 11 wherein the active antenna components are powered electronic devices disposed within or upon the existing infrastructure-based devices.

14. The apparatus of claim 8 wherein a frequency range for the network is approximately 600 MHz-2500 MHz.

15. The apparatus of claim 8 wherein the primary communications system is selected from a group consisting of existing wireless communications networks and wireless Internet service provider networks.
